(19) United States
(12) Patent Application Publication
(10) Pub. No.: US 2017/0243684 A1
(43) Pub. Date: Aug. 24, 2017

(54) SOLENOID WITH LATCH ASSIST

(71) Applicant: BorgWarner Inc., Auburn Hills, MI (US)

(72) Inventors: Philip J. MOTT, Dryden, NY (US); Miguel RAIMAO, Colorado Springs, CO (US)

(21) Appl. No.: 15/505,209

(22) PCT Filed: Aug. 14, 2015
(86) PCT No.: PCT/US2015/045262

§ 371 Date: Feb. 20, 2017

Related U.S. Application Data
(60) Provisional application No. 62/041,432, filed on Aug. 25, 2014.

(51) Int. Cl. H01F 7/121; H01F 7/16

(52) U.S. Cl. CPC H01F 7/121; H01F 7/1607; F16K 31/0665

(57) ABSTRACT

A solenoid is latched in an energized position by a magnetic field established by a low level current in combination with a residual magnetic field established by a pulse of current. Fail-safe return to the de-energized positon occurs when the supply of power is turned off or lost.

### CROSS-REFERENCE TO RELATED APPLICATIONS

This application claims the benefit of U.S. Provisional Application No. 62/041,432 filed Aug. 25, 2014.

### TECHNICAL FIELD

The field to which the disclosure generally relates includes latching solenoids.

### BACKGROUND

Solenoids that latch are used in applications where the solenoid's energized position is needed for extended periods of time. The solenoid is latched in the energized position and remains there, consuming no power, until the solenoid is unlatched.

### SUMMARY OF ILLUSTRATIVE VARIATIONS

A number of variations may include a solenoid with a coil generating a first magnetic field when energized by a first electrical current. The first magnetic field moves an armature away from a de-energized position and toward a fixed stop to an energized position. The first magnetic field establishes a residual magnetic attraction urging the armature toward the stop. The first electrical current may be reduced to a second electrical current that is significantly lower than the first electrical current and which is delivered to the coil, generating a second magnetic field. The second magnetic field in combination with the residual magnetic attraction latches the armature in the energized position.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a solenoid that may be latched according to a number of variations.

FIG. 2 is a graph of current in amperes versus time in seconds for the solenoid of FIG. 1.

### DETAILED DESCRIPTION OF ILLUSTRATIVE VARIATIONS

The following description of the variations is merely illustrative in nature and is in no way intended to limit the scope of the invention, its application, or uses.

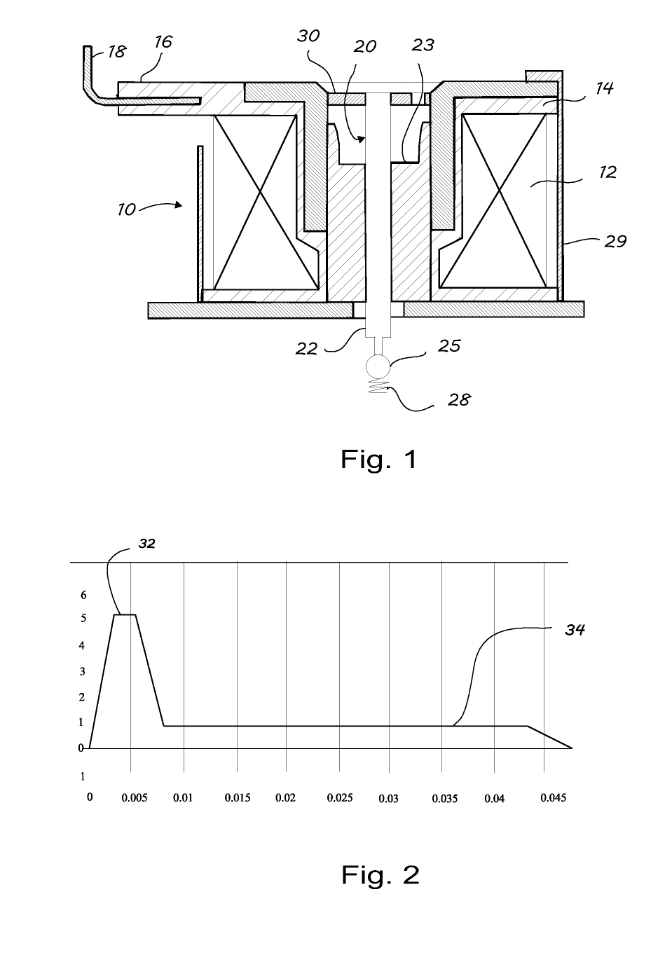

Referring to FIG. 1, a number of variations may include a solenoid 10 that has a coil 12 consisting of several turns of coated wire wound around a bobbin 14. The coil assembly including the wire and bobbin form the shape of the hollow cylinder. The bobbin 14 may be made of molded plastic and includes an integral electrical connector 16 for connecting the ends of the coil's wire with a power supply through lead wires 18. Current is supplied to the solenoid valve from these wires.

An armature assembly 20 is slidably disposed inside the cylindrical coil assembly. The armature assembly may include an extending rod 22 for engaging a device such as a valve ball 25 to be actuated by the solenoid 10 and also includes an armature body 23. When electrical current is applied to the coil assembly's windings, a magnetic field is generated around the coil assembly where the armature assembly is disposed and extends through the armature assembly 20, pole piece 24, case 29 and stop 26. In response to the magnetic field, the armature assembly slides within the center of the coil assembly, which will be downward as shown in FIG. 1.

When current is applied to coil 12 the magnetic field established through the armature assembly 20, pole piece 24, case 29 and stop 26 compresses spring 28 and moves the armature assembly 20 away from a de-energized position where armature body 23 is against plate 30 and toward stop 26 to the energized position shown in FIG. 1. When the supply of current is stopped, a residual magnetic field remains in the ferromagnetic elements of the solenoid 10 including stop 26 and armature body 23, that however is insufficient to hold the armature assembly in the energized position and with no current supplied to coil assembly 12, the spring 28 forces the armature assembly 20 up away from stop 26 and against plate 30.

Referring to FIG. 2 a number of variations may include a method of holding the armature assembly 20 in the energized position. A pulse of current 32 is applied to coil 12 of 5 amperes for approximately 2.5 milliseconds. This current pulse moves the armature body 23 against stop 26 to the energized position. The supply of current is then reduced to approximately 0.9 amperes and maintained at that level. The reduced current 34 has the same polarity as the current pulse so as to urge the armature assembly in the same direction toward stop 26. In this manner the combination of the residual magnetic field resulting from the current pulse 32 and the magnetic field established by the 0.9 ampere current supply overcomes the force of spring 28 and holds the armature body 23 against stop 26 in the energized position. Through the combination of magnetic fields the solenoid is latched in position. When return of the armature assembly to the de-energized position is desired, the 0.9 ampere current supply is turned off and the spring 28 overcomes the residual magnetic field in the ferromagnetic elements, and armature assembly 20 returns to the de-energized position against plate 30. In this manner a fail-safe means of operation is provided wherein any loss of supplied current will return the solenoid to the de-energized position, since the residual magnetic field is itself, incapable of holding the solenoid in the energized position.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still considered to be within the scope of the invention.

Variation 1 may include a solenoid having a coil generating a first magnetic field when energized by a first electrical current. The first magnetic field moves an armature away from a de-energized position and toward a fixed stop to an energized position. The first magnetic field establishes a residual magnetic attraction that resides when the first electrical current is removed. The first electrical current is reduced to a second electrical current that is significantly lower than the first electrical current. The second electrical current is delivered to the coil, generating a second magnetic field that in combination with the residual magnetic attraction latches the armature in the energized position.

Variation 2 may include a solenoid as set forth in variation 1 wherein the first electrical current and the second electrical current have a polarity that is the same.

Variation 3 may include a solenoid as set forth in variation 1 or 2 wherein when the second electrical current is stopped, the armature moves to the de-energized position.

Variation 4 may include a solenoid as set forth in any of variations 1 through 3 where the residual magnetic attraction by itself is insufficient to hold the armature in the energized position.

Variation 5 may include a solenoid as set forth in any of variations 1 through 4 wherein the second electrical current may be less than 1 ampere. Variation 6 may include a solenoid as set forth in any of variations 1 through 5 wherein the second electrical current may be less than 20 percent of the first electrical current in magnitude.

Variation 7 may include a solenoid as set forth in any of variations 1 through 6 wherein the stop helps conduct the first and second magnetic fields. Variation 8 may include a solenoid having a coil with a winding having a plurality of turns through which an energizing electrical current is selectively passed. The coil generates a magnetic field when exposed to the energizing electrical current. The magnetic field moves an armature away from a de-energized position and toward a fixed stop to an energized position. The magnetic field establishes a magnetic attraction between the armature and the stop. The electrical current may be reduced by a minimum of 50 percent to a reduced electrical current, a residual magnetic attraction created by the energizing electrical current in combination with the reduced electrical current holds the armature in the energized position.

Variation 9 may include a solenoid as stated in variation 8 wherein the energizing electrical current may be applied for approximately 2.5 milliseconds and the reduced electrical current is applied to maintain the armature in the energized position until return of the armature to the de-energized position is desired, or until power is interrupted.

Variation 10 may include a solenoid as stated in variation 8 or 9 wherein the energizing electrical current may be approximately 5 amperes and the reduced electrical current may be approximately 0.9 ampere.

Variation 11 may include a method of holding a solenoid in an energized position. A first current is applied for a relatively short pulse. The first current moves the solenoid from a de-energized position to an energized position and establishes a residual magnetic field. A reduced current is applied for an extended period of time establishing an applied magnetic field. A combination of the residual magnetic field and the applied magnetic field is used to hold the solenoid in the energized position.

Variation 12 may include a method as stated in variation 11 including providing a fail-safe return of the solenoid to the de-energized position where a loss of current returns the solenoid to the de-energized position.

The above description of select variations within the scope of the invention is merely illustrative in nature and, thus, variations or variants thereof are not to be regarded as a departure from the spirit and scope of the invention.

What is claimed is:

1. A solenoid comprising a coil generating a first magnetic field when energized by a first electrical current, the first magnetic field moving an armature away from a de-energized position and toward a fixed stop to an energized position and establishing a residual magnetic attraction that resides when the first electrical current is removed, wherein the first electrical current is reduced to a second electrical current that is significantly lower than the first electrical current and is delivered to the coil generating a second magnetic field that in combination with the residual magnetic attraction holds the armature in the energized position.

2. A solenoid according to claim 1 wherein the first electrical current and the second electrical current have a polarity that is the same.

3. A solenoid according to claim 1 wherein when the second electrical current is stopped, the armature moves to the de-energized position.

4. A solenoid according to claim 1 wherein the residual magnetic attraction by itself is insufficient to hold the armature in the energized position.

5. A solenoid according to claim 1 wherein the second electrical current is less than 1 ampere.

6. A solenoid according to claim 1 wherein the second electrical current is less than 20 percent of the first electrical current in magnitude.

7. A solenoid according to claim 1 wherein the stop helps conduct the first and second magnetic fields.

8. A solenoid comprising a coil with a winding through which an energizing electrical current is selectively passed, the coil generating a magnetic field when exposed to the energizing electrical current, the magnetic field moving an armature away from a de-energized position and toward a fixed stop to an energized position and establishing a magnetic attraction between the armature and the stop wherein when the electrical current is reduced by a minimum of 50 percent to a reduced electrical current, a residual magnetic attraction created by the energizing electrical current in combination with the reduced electrical current holds the armature in the energized position.

9. A solenoid according to claim 8 wherein the energizing electrical current is applied for approximately 2.5 milliseconds and the reduced electrical current is applied to maintain the armature in the energized position until return of the armature to the de-energized position is desired, or until power is interrupted.

10. A solenoid according to claim 8 wherein the energizing electrical current is approximately 5 amperes and the reduced electrical current is approximately 0.9 ampere.

11. A method of holding a solenoid in an energized position including the steps of: applying a first current for a relatively short pulse;
moving the solenoid from a de-energized position to an energized position; establishing a residual magnetic field through the first current; applying a reduced current for an extended period of time;
establishing an applied magnetic field through the reduced current; and utilizing a combination of the residual magnetic field and the applied magnetic field to hold the solenoid in the energized position.

12. A method according to claim 11 including providing a fail-safe return of the solenoid to the de-energized position wherein a loss of current returns the solenoid to the de-energized position.
